(19) United States
(12) Patent Application Publication
(10) Pub. No.: US 2025/0091868 A1
(43) Pub. Date: Mar. 20, 2025

(54) APPARATUS AND METHOD FOR PRODUCING TRIFLUORAMINE OXIDE

(71) Applicant: SK SPECIALTY CO., LTD, Yeongju-si, Gyeongsangbuk-do (KR)

(72) Inventors: Sung Woong CHUNG, Yeongju-si, Gyeongsangbuk-do (KR); Jung Hun KWAK, Yeongju-si, Gyeongsangbuk-do (KR); Byung Hyang KWON, Yeongju-si, Gyeongsangbuk-do (KR); Yong Jun CHO, Yeongju-si, Gyeongsangbuk-do (KR)

(73) Assignee: SK SPECIALTY CO., LTD, Yeongju-si, Gyeongsangbuk-do (KR)

(21) Appl. No.: 18/727,225

(22) PCT Filed: Jan. 19, 2023
(86) PCT No.: PCT/KR2023/000925

§ 371 Date: Jul. 8, 2024

(30) Foreign Application Priority Data
Jan. 21, 2022 (KR) 10-2022-0009443

(51) Int. Cl. C01B 21/084

(52) U.S. Cl. CPC C01B 21/0842

(57) ABSTRACT

An apparatus for producing trifluoramine oxide includes: a reactor in which a photochemical reaction for generating trifluoramine oxide by using vapor-phase FNO and F₂ as starting materials is performed; an ultraviolet irradiation means for irradiating ultraviolet rays having a peak wavelength in a wavelength band of 300 nm to 400 nm into the reactor; and a separation and collection means which is in vapor communication with the reactor, separating and collecting generated trifluoramine oxide from reaction products generated in the reactor. The ultraviolet rays are such that an intensity of rays having a wavelength band of less than 300 nm is less than 5% of an intensity of rays having a wavelength band of 300 nm to 400 nm.

### CROSS-REFERENCE TO PRIOR APPLICATIONS

This Application is a National Stage Patent Application of PCT International Application No. PCT/KR2023/000925 (filed on Jan. 19, 2023), which claims priority to Korean Patent Application No. 10-2022-0009443 (filed on Jan. 21, 2022), which are all hereby incorporated by reference in their entirety.

### BACKGROUND

The present invention relates to a method for preparing trifluoramine oxide (F₃NO).

A Chemical Vapor Deposition (CVD) process is widely known as a thin film forming process for manufacturing a semiconductor device or a display device. When the thin film of the semiconductor device or the display device is formed in the CVD chamber, the thin film is preferably formed only on a target object in the CVD chamber, but the thin film forming material is inadvertently deposited on other exposed surfaces in the CVD chamber. For example, a thin film forming material may also be deposited on a wall surface in the CVD chamber. In addition, the surface of the thin film deposited on the target object or the surface of the target object on which the thin film is to be formed may be contaminated by debris fallen from the materials deposited in addition to the target object during the CVD process. Such contamination may cause defects in the semiconductor device or the display device, resulting in a drop in yield. Therefore, a cleaning process is performed to remove unnecessary deposits deposited in the CVD chamber with a suitable period. The cleaning process of the inside of the CVD chamber may be manually performed or may be performed using a cleaning gas.

Perfluorinated materials such as CF₄, C₂F₆, SF₆, and NF₃ have been used as for a chamber cleaning gas or an etching gas for a deposited thin film in a semiconductor or electronic device manufacturing process.

However, such perfluorinated materials are present in the atmosphere for a very long period of time as stable materials. In addition, since a waste gas after use contains a high concentration of undecomposed perfluorinated substances, the waste gas should be treated to contain undecomposed perfluorinated substances less than or equal to an allowable reference value, and thus a lot of costs are required for treating the waste gas before emitting into the atmosphere. Moreover, these conventional perfluorinated materials are known to have very high Global Warming Potential (GWP) values (CF₄ 6,630, SF₆ 23,500, NF₃ 16,100, ITH, 100 years, CO2-equivalent), and a significant load in the environment. Therefore, the need for a substitute gas which has a low GWP value and can be used in a cleaning or etching process, is very high.

In particular, nitrogen trifluoride (NF₃) gas is globally heavily used and has a very high global warming potential. Therefore, there is a need to reduce the use of NF₃ gas and develop substitute materials that contributes to reducing environmental effect, promoting sustainability and advancing the semiconductor industry.

Among substitute gas candidates, trifluoramine oxide (F₃NO) has an extremely low expected GWP and exhibits performance comparable to NF₃ gas currently used as a cleaning gas. F₃NO has a very high content of ‘F’ that determines etching and cleaning performance, is expected to have a low global warming potential unlike non-degradable PFC, HFC, NF₃, and SF₆, is expected to have low energy and environmental load required for treating non-reacted residual F₃NO, and is non-irritating upon leakage.

A little is known about the method of preparing trifluoramine oxide (F₃NO), an alternative gas candidate material.

Patent Document 1 (US Patent Application Publication No. 2003/0143846 A1) relates to a technology relating to a gas composition for etching the inside of a reactor and etching a film of a silicon-containing compound, and discloses the gas composition comprising F₃NO and a method of synthesizing F₃NO by reacting NF₃ and N₂O at a temperature of 150° C. under a SbF₅ catalyst to obtain NF₂OSb₂F₁₁ salt and then pyrolyzing the salt at a high temperature (>200° C.). However, the yield in relation to NF₃ and N₂O, which are the starting materials, is as low as 20%, and the purity of the final product is low.

The applicant of the present application has suggested a novel method capable of preparing trifluoramine oxide with high yield and purity while using the SbF₅/NF₃/N₂O reaction system as in Patent Document 1, respectively, in Patent Document 2 (Korean Patent Registration No. 10-2010460 B1) and Patent Document 3 (Korean Patent No. 10-2010466 B1). For example, according to the method disclosed in Patent Document 2, NF₃ and N₂O are reacted under SbF₅ to obtain an intermediate product NF₂OSbF₆, and the intermediate product is contacted with NaF and thermally decomposed under a vacuum atmosphere to synthesize trifluoramine oxide (F₃NO) through a two-step reaction. In addition, according to the method disclosed in Patent Document 3, the intermediate product is prepared by reacting NF₃ and N₂O under SbF₅ while removing reaction gases and nitrogen (N₂) generated by the reaction and additionally injecting nitrogen trifluoride and nitrous oxide, and the intermediate product is reacted with NaF to synthesize trifluoramine oxide (F₃NO).

### PRIOR ART

(Patent Document 1) US Patent Application Publication No. 2003/0143846 A1
(Patent Document 2) Korean Patent Registration No. 10-2010460 B1
(Patent Document 3) Korean Patent Registration No. 10-2010466 B1

### SUMMARY

However, according to the method for synthesizing trifluoramine oxide disclosed in Patent Document 2 and Patent Document 3, it is necessary to heat the intermediate product at a temperature of about 150° C. to 200° C. under a vacuum atmosphere for the reaction of the second step of reacting the intermediate product with NaF. As a result, it is not only necessary to use an expensive reactor capable of performing a vacuum process, but also requires a heating process for pyrolysis, thereby increasing the manufacturing cost of trifluoramine oxide. In addition, since the progress rate of the pyrolysis reaction is slow, a considerable time is taken for the pyrolysis reaction, and the solid-phase reaction is not a continuous reaction, and thus productivity is not high. In addition, there is a stability problem of the manufacturing facility due to the pipe clogging.

Therefore, one object to be solved by the present invention is to provide a method for preparing trifluoramine oxide, which can suppress an increase in manufacturing costs, has high productivity, can reduce an influence on a manufacturing facility, and can improve yield.

An apparatus for preparing trifluoramine oxide according to an embodiment of the present invention for solving the above problem comprises: a reactor in which a photochemical reaction of generating trifluoramine oxide by using vapor-phase FNO and F₂ as starting materials is performed; an ultraviolet irradiation means for irradiating ultraviolet rays having a peak wavelength in a wavelength band of 300 nm to 400 nm into the reactor; and a separation and collection means which is in vapor communication with the reactor, separating and collecting generated trifluoramine oxide from the reaction products generated in the reactor; wherein the ultraviolet rays are such that an intensity of rays having a wavelength band of less than 300 nm is less than 5% of an intensity of rays having a wavelength band of 300 nm to 400 nm.

A method for preparing trifluoramine oxide according to another embodiment of the present invention comprises the steps of: supplying vapor phase FNO and F₂ into a reactor; irradiating ultraviolet rays having a peak wavelength in a wavelength band of 300 nm to 400 nm into the reactor; discharging the products from the reactor; and separating and collecting F₃NO from the discharged products, wherein the ultraviolet rays are such that an intensity of rays having a wavelength band of less than 300 nm is less than 5% of an intensity of rays having a wavelength band of 300 nm to 400 nm.

According to the present invention, it is possible to suppress the increase in the manufacturing cost of trifluoramine oxide, to increase productivity, and to reduce the influence on manufacturing equipment such as pipe clogging. In particular, according to the preparation method of the present invention, it is possible to improve the yield of trifluoramine oxide.

### BRIEF DESCRIPTION OF THE DRAWINGS

FIG. 1 is a schematic view illustrating an apparatus for preparing trifluoramine oxide according to an embodiment of the present invention.

FIG. 2 is a graph showing a spectrum of an ultraviolet ray source of the apparatus and a spectrum of the ultraviolet rays filtered by a bandpass filter according to an embodiment of the present invention.

FIG. 3 is an emission spectrum of an ultraviolet LED as an ultraviolet irradiation means of the apparatus according to another embodiment of the present invention.

FIG. 4 is a flowchart illustrating a method of preparing trifluoramine oxide according to an embodiment of the present invention.

### DETAILED DESCRIPTION

Hereinafter, preferred embodiments and examples of the present invention will be described with reference to the drawings. However, the following embodiments and examples are merely illustrative of preferred configurations of the present invention, and the scope of the present invention is not limited to these configurations. In the following description, the hardware configuration and software configuration, process flow, manufacturing conditions, size, material, shape, and the like of the apparatus are not intended to limit the scope of the present invention, unless particularly specified.

According to the method for preparing trifluoramine oxide of the present invention, vapor phase FNO and F₂ are used as starting materials, and a mixture of these starting materials is irradiated with ultraviolet rays, which have a peak wavelength in the band of 300 nm to 400 nm and substantially lack wavelength components of less than 300 nm, to prepare trifluoramine oxide by photochemical fluorination. That is, the method for preparing trifluoramine oxide according to the present invention is performed by the following reaction scheme.

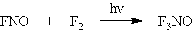

Accordingly, there is no need for a vacuum installation as a reactor and additional heating is not required for the reaction, thereby reducing manufacturing costs. In addition, it is possible to improve productivity due to a fast reaction rate, and since the reaction rate is a vapor phase reaction, manufacturing equipment breakdowns such as pipe clogging can be reduced.

In particular, in the method for preparing trifluoramine oxide of the present invention, since ultraviolet rays irradiated to a mixture of starting materials substantially do not have a wavelength component of less than 300 nm, side reactions other than a product F₃NO can be suppressed, and the yield of F₃NO can be improved.

Hereinafter, an apparatus for preparing trifluoramine oxide according to the present invention and a preparation method using the same according to the present invention will be described in detail with reference to the accompanying drawings.

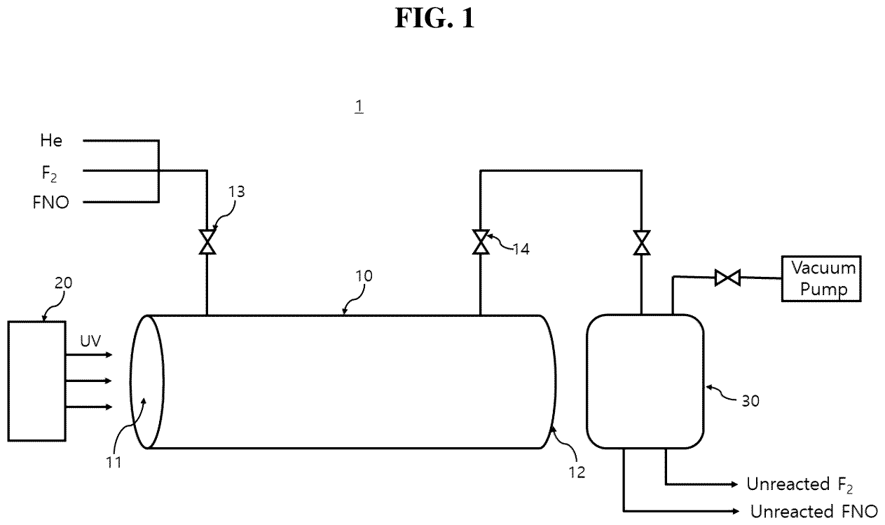

FIG. 1 is a schematic view showing an apparatus for preparing trifluoramine oxide according to an embodiment of the present invention.

The apparatus 1 for preparing trifluoramine oxide according to an embodiment of the present invention includes a reactor 10, an ultraviolet irradiation means 20, and a separation and collection means 30 of trifluoramine oxide.

As shown in FIG. 1, the reactor 10 has an elongated tube shape with both ends closed, and includes, for example, a cylindrical body portion and end plates 11 and 12 installed at both ends of the body portion.

The reactor 10 is preferably made of a material resistant to product such as F₃NO or starting materials such as FNO and F₂. For example, the reactor 10 may be made of Monel, nickel, stainless steel, or Teflon.

At least one window transparent to ultraviolet rays is installed in the reactor 10. For example, at least one of the end plates 11 and 12 installed at both end portions in the longitudinal direction of the reactor 10 is made of a material that is transparent to ultraviolet rays so as to allow ultraviolet rays of a predetermined wavelength band irradiated from the ultraviolet irradiation means 20 to be incident into the reaction space of the reactor 10. Specifically, the end plate 11 close to the inlet of the starting materials among both end plates 11 and 12 of the reactor 10 is made of a material, for example, barium fluoride or calcium fluoride, transparent to ultraviolet rays.

However, the present invention is not limited to this configuration, and both end plates 11 and 12 may be made of a material transparent to ultraviolet rays, and one or more transparent windows may be additionally installed on the longitudinal cylindrical surface of the reactor 10.

On the longitudinal cylindrical surface of the reactor 10, inlets and inlet valves 13 for introducing starting materials such as FNO and F₂ or a purging gas (He) are provided at positions adjacent to the ultraviolet irradiating means 20, and outlets and outlet valves 14 for discharging product materials are provided at the opposite end.

The ultraviolet irradiation means 20 irradiates ultraviolet rays of a predetermined wavelength band into the reactor 10 so that the starting materials FNO and F₂ react with each other to generate F₃NO.

The ultraviolet rays irradiated by the ultraviolet irradiation means 20 substantially do not have a wavelength band of less than 300 nm, and have a peak wavelength in a wavelength band of 300 nm to 400 nm. For example, the ultraviolet rays irradiated by the ultraviolet irradiation means 20 are such that an intensity of rays having a wavelength band of less than 300 nm is less than 5% of an intensity of rays having a wavelength band of 300 nm to 400 nm.

As described above, since the ultraviolet rays irradiated by the ultraviolet irradiation means 20 do not have a high energy component (deep ultraviolet, Deep UV) of a wavelength band of less than 300 nm, side reactions can be suppressed by high energy components of this wavelength band, and a decrease in the yield of F₃NO can be suppressed.

To this end, the ultraviolet irradiation means 20 of the apparatus 1 for preparing trifluoramine oxide according to an embodiment of the present invention includes an ultraviolet ray source (not shown) and a filter (not shown) for cutting off the deep ultraviolet component of less than 300 nm from the ultraviolet rays emitted from the ultraviolet ray source or a bandpass filter (not shown) for passing only a component of the wavelength band of 300 nm to 400 nm.

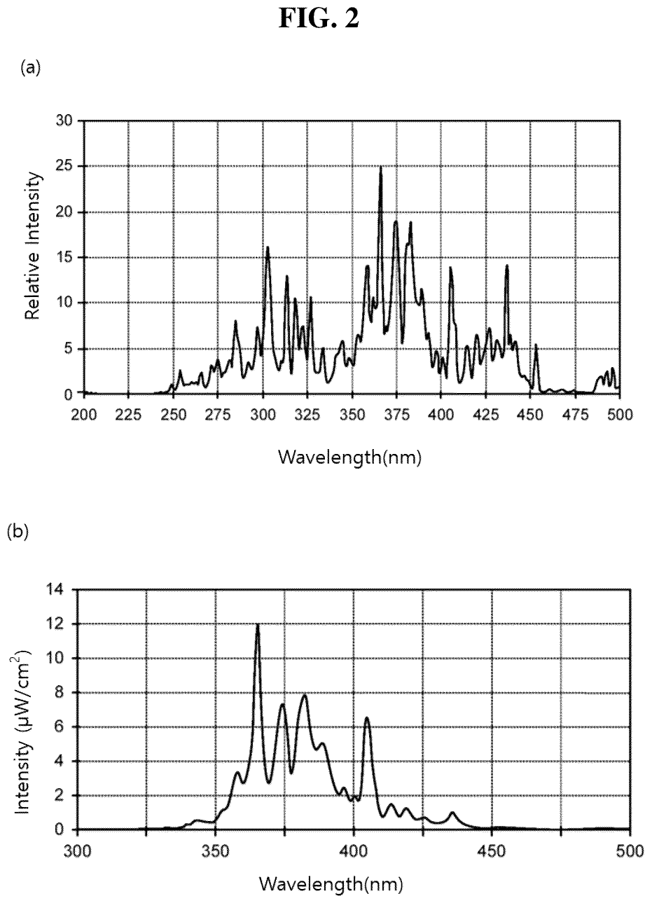

Examples of the ultraviolet ray source may include a metal halogen lamp (which may include metals such as Fe, Tl, Sn, Zn, Hg, which have emission properties in the ultraviolet wavelength band) having a peak wavelength in the ultraviolet wavelength band, a xenon lamp, a mercury xenon lamp, a halogen lamp, or the like. As shown in (a) of FIG. 2, the ultraviolet ray source has a peak wavelength in a wavelength band of 300 nm to 400 nm, but also has a deep ultraviolet component of less than 300 nm and a visible light/infrared component of more than 400 nm.

Here, as described above, the component of the deep ultraviolet wavelength band of less than 300 nm causes a side reaction when the F₃NO is generated in the reactor 10, thereby reducing the yield of F₃NO. In addition, the visible light/infrared component of more than 400 nm increases the temperature of the ultraviolet irradiation means 20, thereby degrading the function of the bandpass filter.

Accordingly, in one embodiment of the present invention, the bandpass filter includes a deep ultraviolet cut-off filter (first filter) for cutting off the deep ultraviolet component of less than 300 nm and a visible light/infrared cut-off filter (second filter) for cutting off the visible light/infrared component of greater than 400 nm. For example, the deep ultraviolet cut-off filter may be formed of an oxide optical filter capable of scattering or reflecting the deep ultraviolet wavelength component, such as TiO₂, and the visible light/infrared cut-off filter may be composed of an optical filter capable of reflecting or absorbing the wavelength component of greater than 400 nm, such as SiO₂ and ZrO₂ or CeO₂. However, the present invention is not limited thereto, and an optical filter made of other materials may be used if deep ultraviolet rays and visible light/infrared can be cut off. For example, an optical filter including a silver (Ag) thin film may be used.

Here, the deep ultraviolet cut-off filter has a film thickness of TiO₂ such that the transmittance of ultraviolet rays having a wavelength band of less than 300 nm is less than 5% of the transmittance of ultraviolet rays having a wavelength band of 300 nm to 400 nm.

As shown in (b) of FIG. 2, the ultraviolet rays passing through the bandpass filter according to an embodiment of the present invention substantially have an ultraviolet component in the wavelength band of 300 nm to 400 nm.

The ultraviolet rays irradiated by the ultraviolet irradiation means 20, more preferably, has a peak wavelength in a wavelength band of 350 nm to 370 nm, and the intensity of ultraviolet rays in the wavelength band of less than 300 nm is less than 1% of the intensity of ultraviolet rays in the wavelength band of 300 nm to 400 nm. To this end, the bandpass filter of the ultraviolet irradiation means 20 has a configuration such that the transmittance of ultraviolet rays in the wavelength band of less than 300 nm is less than 1% of the transmittance of ultraviolet rays having a wavelength band of 300 nm to 400 nm.

Most preferably, the ultraviolet ray irradiated by the ultraviolet irradiation means 20 is a single wavelength (so-called i-line) of 365 nm. To this end, the ultraviolet irradiation means 20 according to an embodiment of the present invention includes an ultraviolet ray source (not shown) and a single wavelength pass filter (not shown). Here, the single wavelength pass filter is a narrow bandpass filter including Ta₂O₃ and SiO₂, and passes only an ultraviolet (i-line) component having a wavelength of 365 nm.

In the present embodiment, it has been described that the ultraviolet irradiation means 20 uses an ultraviolet ray source such as a metal halogen lamp, but the present invention is not limited thereto, and a UV LED having a peak wavelength in the wavelength band of 300 nm to 400 nm, more preferably, in the wavelength band of 350 to 370 nm may be used.

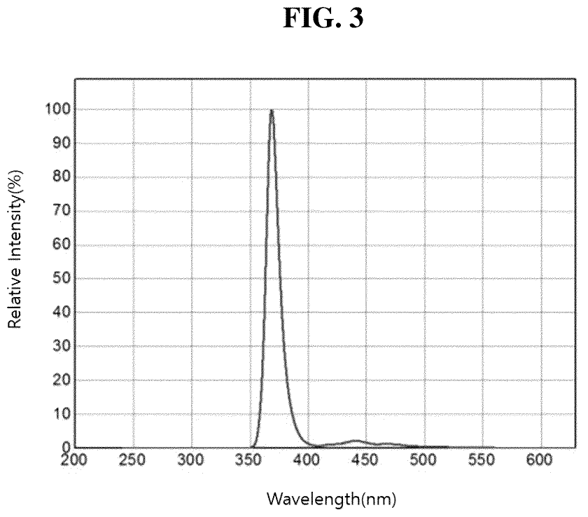

For example, the ultraviolet irradiation means 20 of the apparatus 1 according to another embodiment of the present invention may use a UV LED having an emission spectrum as illustrated in FIG. 3.

The UV LED having such emission properties has a peak wavelength in the wavelength band of 350 to 370 nm, and thus, compared to a case having a peak wavelength in a shorter wavelength band (for example, 300 nm to 350 nm), it is possible to effectively suppress side reactions in the result of the reaction, thereby further improving the yield of F₃NO. In addition, since the LED has a short time until the output of light is stabilized after a current flows to a substrate circuit for controlling light emission and does not need to always emit light like an ultraviolet lamp, the LED has an advantage of saving energy and having a long lifespan. In addition, since the emission spectrum is concentrated in a narrow wavelength band as compared to the ultraviolet lamp, the structure of the bandpass filter may be simplified or the bandpass filter may be omitted, thereby suppressing the decrease in intensity of the ultraviolet rays passing through the bandpass filter. Accordingly, the ultraviolet irradiation time may be reduced to improve productivity.

As another example of the ultraviolet irradiation means 20, an excimer laser may be used. For example, as a laser emitting a single wavelength ray in the wavelength band of 300 nm to 400 nm, XeCl excimer laser (wavelength of 308 nm) and XeF excimer laser (wavelength of 351 nm) may be used.

In FIG. 1, the ultraviolet irradiation means 20 is illustrated as being disposed near the end plate 11 installed at one end of the reactor 10 in the longitudinal direction, but the present invention is not limited thereto.

For example, in the apparatus 1 for preparing trifluoramine oxide according to another embodiment of the present invention, both the end plate 11 (first end plate) installed at one end of the reactor 10 and the end plate 12 (second end plate) disposed at the other end are formed of a material transparent to ultraviolet rays, and the ultraviolet irradiation means 20 may include a first ultraviolet irradiation means for irradiating ultraviolet rays through the end plate 11, and a second ultraviolet irradiation means for irradiating ultraviolet rays through the end plate 12.

With this configuration, ultraviolet rays may be sufficiently irradiated into the reaction space through both end plates 11 and 12 of the reactor 10, thereby further improving the yield of the product.

The apparatus 1 for preparing trifluoramine oxide according to an embodiment of the present invention includes a cold trap as the separation and collection means 30 for separating and collecting trifluoramine oxide from the products discharged to the outside of the reactor 10 in a gaseous state.

In addition to the trifluoramine oxide, the gaseous products discharged from the reactor 10 may include unreacted FNO, F₂, etc. and since the boiling point of the trifluoramine oxide is-89° C. which falls between the boiling point of FNO (−56° C.) and the boiling point of F₂ (−188° C.), the cold trap as the separation and collection means 30 for trifluoramine oxide is preferably composed of at least two stages. That is, the first cold trap may first condense and separate FNO from the gaseous products discharged through the outlet valve 14 of the reactor 10, and the second cold trap may condense and separate trifluoramine oxide from the vapor stream discharged from the first cold trap. F₂ gas included in the vapor stream discharged from the second cold trap may be removed through a scrubber. However, the present invention is not limited thereto, and other means capable of separating and collecting trifluoramine oxide discharged in the gaseous phase may be used.

Although not shown in FIG. 1, the apparatus 1 for preparing trifluoramine oxide according to an embodiment of the present invention may further include a temperature control unit (not shown) for adjusting the ultraviolet irradiation means 20 and the reactor 10 to an appropriate temperature. For example, a blowing means or a chiller may be used as the temperature control means. When the temperature of the reactor 10 is controlled by the refrigerant of the chiller, it is preferable to install the refrigerant pipe of the chiller on the cylindrical surface in the longitudinal direction of the reactor 10.

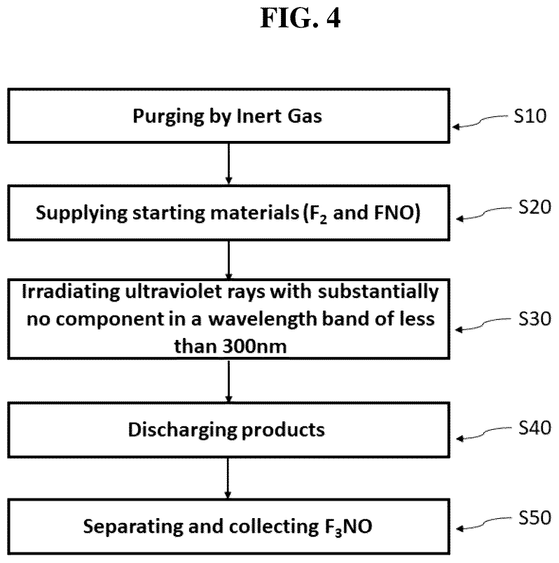

Hereinafter, a method of preparing trifluoramine oxide according to an embodiment of the present invention will be described in detail with reference to FIG. 4. The preparation method according to an embodiment of the present invention is described as a batch process, but the present invention is not limited thereto, and may be carried out in a continuous manner or a combination thereof.

First, an inert gas (for example, helium) is supplied into the reactor 10 to purge the reaction space in the reactor 10 (step S10). Accordingly, the gaseous products remaining in the reactor 10 in the previous batch process may be completely removed from the reactor 10.

Then, F₂ and FNO as starting materials are supplied into the reactor 10 (S20). At this time, the inlet valve 13 as well as the outlet valve 14 are also opened so that the reaction zone in the reactor 10 is flushed by the mixture of starting materials, and when the flushing is completed, the inlet valve 13 and the outlet valve 14 are closed and the reaction region in the reactor 10 is filled with a mixture of starting materials.

In the step of supplying the starting materials, F₂ and FNO as the starting materials are supplied at a ratio of 0.5 to 2.5 moles of F₂ per mole of FNO. More preferably, the molar ratio of F₂ to FNO is 0.5 to 1.2:1, even more preferably 1:1.

In the present embodiment, it has been described that F₂ and FNO as the starting materials are supplied simultaneously (or a mixture thereof) through the inlet valve 13, but the present invention is not limited thereto, and any one of the starting materials is first supplied to flush the reaction zone of the reactor 10, and then another starting material is supplied to fill the reaction zone of the reactor 10 with the two starting materials. For example, F₂ gas may be first fed into the reactor 10 to flush the reaction zone, and then FNO may be fed into the reactor 10.

When the supply of the starting materials is completed, ultraviolet rays of a predetermined wavelength band are irradiated by the ultraviolet irradiation means 20 through a transparent window installed on the end plate 11 of the reactor 10 (S30). As described above, the ultraviolet rays irradiated in the ultraviolet irradiation step (S30) have a peak wavelength in the wavelength band of 300 nm to 400 nm, and substantially do not include an ultraviolet component in the wavelength band of less than 300 nm. For example, as shown in (b) of FIG. 2 or FIG. 3, the ultraviolet rays irradiated in the ultraviolet irradiation step (S30) have a peak wavelength at 365 nm, and the intensity of the ultraviolet rays in the wavelength band of less than 300 nm is 5% or less of the intensity of the ultraviolet rays in the wavelength band of 300 nm to 400 nm, and more preferably 1% or less of the intensity of the ultraviolet rays in the wavelength band of 300 nm to 400 nm. Most preferably, the ultraviolet ray is a single wavelength ray having a wavelength of 365 nm and does not include an ultraviolet component in the wavelength band of less than 300 nm.

The ultraviolet irradiation step (S30) is preferably performed for 2 to 6 hours so that the starting materials in the reactor 10 are sufficiently reacted to generate F₃NO. If it is less than 2 hours, a sufficient amount of F₃NO may not be generated in the reactor 10 at the mass production scale, and if it exceeds 6 hours, the generating rate of F₃NO becomes slow down with increasing ultraviolet irradiation time, and thus, it may become uneconomical. In the present embodiment, the starting materials filled in the reactor 10 at a molar ratio of 1:1 were irradiated with a single wavelength ultraviolet ray of 365 nm for 3 hours to achieve a yield of 80% based on a reaction pressure.

More preferably, during the initial batch process, data on the amount generated (or yield) based on varying ultraviolet irradiation times may be acquired, the optimal ultraviolet irradiation time can be determined in consideration of the balance between the generating amount (or yield) of F₃NO and productivity, and in the subsequent batch processes, ultraviolet irradiation may be performed for the determined optimal ultraviolet irradiation time.

However, the intensity of ultraviolet rays emitted from the ultraviolet irradiation means 20 may drop over time, and the transmittance of the transparent window of the reactor 10 may be deteriorated by the continuous exposure to the ultraviolet rays, and thus it is preferable to adjust the ultraviolet irradiation time according to the cumulative use time of the ultraviolet irradiation means 20. For example, it is preferable to acquire data on the relationship between the ultraviolet irradiation time and the amount (yield) of F₃NO generated for each predetermined number of batch processes, and adjust the ultraviolet irradiation time for the subsequent batch process.

For more accurate control of the reaction progress in the reactor 10 or the ultraviolet irradiation time, the amount of F₃NO generated in the reactor 10 may be measured in real time by the infrared spectroscopy during the ultraviolet irradiation step (S30), and the ultraviolet irradiation time may be feedback-controlled.

During the ultraviolet irradiation step (S30), the temperature in the reactor 10 is maintained at 15° C. to 75° C., more preferably at 25° C. to 50° C. Since the temperature in the reactor 10 may vary due to the reaction heat of the synthesis reaction and the heat transfer from the ultraviolet irradiation means 20 during the ultraviolet irradiation, it is preferable to maintain the temperature within the predetermined temperature range by a temperature control means such as a blower or a chiller.

When the ultraviolet irradiation is completed, the outlet valve 14 is opened to discharge the reaction product mixture in the reactor 10 to the outside of the reactor 10 (S40). At this time, the reaction products in the reactor 10 may be discharged by the pressure difference, and the inlet valve 13 may be opened to blow an inert gas (for example, helium) to promote the discharge of the reaction product.

When the reaction products including F₃NO are sufficiently discharged, F₃NO is separated and collected from the reaction product stream by the cold trap as the separation and collection means 30 of trifluoramine oxide (S50). As described above, in the reaction product stream, unreacted FNO or F₂ may be contained in addition to F₃NO, FNO having a boiling point higher than that of F₃NO is first separated from the reaction product stream by the first cold trap, and then F₃NO is separated and collected by the second cold trap. The separated and collected F₃NO may be purified by fractional distillation as necessary.

Accordingly, when one batch process is completed, the process proceeds back to the purging step (S10), and the next batch process is performed.

As described above, the above description is merely an example, and the present invention should not be construed as being limited thereto. The technical spirit of the present invention should be specified only by the invention as set forth in the following claims, and all technical ideas within the scope equivalent thereto should be construed as being included in the scope of the present invention. Therefore, it will be obvious to a person skilled in the art that the above-described embodiments may be modified in various forms.

### DESCRIPTION OF SYMBOLS

10: Reactor
20: ultraviolet irradiation means
30: Separation and collection means

1. An apparatus for preparing trifluoramine oxide, comprising:
a reactor in which a photochemical reaction for generating trifluoramine oxide by using vapor-phase FNO and F₂ as starting materials is performed;
an ultraviolet irradiation means for irradiating ultraviolet rays having a peak wavelength in a wavelength band of 300 nm to 400 nm into the reactor; and
a separation and collection means which is in vapor communication with the reactor, separating and collecting generated trifluoramine oxide from reaction products generated in the reactor;
wherein the ultraviolet rays are such that an intensity of rays having a wavelength band of less than 300 nm is less than 5% of an intensity of rays having a wavelength band of 300 nm to 400 nm.

2. The apparatus of claim 1, wherein the ultraviolet rays have a peak wavelength in a wavelength band of 350 nm to 370 nm, and the intensity of the rays having the wavelength band of less than 300 nm is 1% less than the intensity of the rays having the wavelength band of 300 nm to 400 nm.

3. The apparatus of claim 2, wherein the ultraviolet rays have a single wavelength of 365 nm.

4. The apparatus of claim 1, wherein the ultraviolet irradiation means includes an ultraviolet ray source having an emission spectrum having a peak in a wavelength band of 300 nm to 400 nm and a bandpass filter for passing a wavelength component in a wavelength band of 300 nm to 400 nm among the rays emitted from the ultraviolet ray source.

5. The apparatus of claim 4, wherein the bandpass filter includes a first filter cutting off a wavelength band of less than 300 nm and a second filter cutting off a wavelength band of greater than 400 nm.

6. The apparatus of claim 4, wherein the bandpass filter is a single wavelength filter that substantially passes only ultraviolet rays having a single wavelength of 365 nm.

7. The apparatus of claim 4, wherein the ultraviolet ray source is a metal halogen lamp, a mercury xenon lamp, a xenon lamp, or a halogen lamp.

8. The apparatus of claim 1, wherein the ultraviolet irradiation means is an ultraviolet (UV) LED.

9. The apparatus of claim 1, wherein the ultraviolet irradiation means is an excimer laser emitting ultraviolet rays having a single wavelength.

10. The apparatus of claim 1, wherein the separation and collection means is a cold trap.

11. The apparatus of claim 10, wherein the cold trap comprises a first cold trap for collecting an unreacted starting material from the reaction products and a second cold trap for collecting trifluoramine oxide.

12. The apparatus of claim 1, wherein the reactor comprises a cylindrical body portion and end plates disposed at both ends of the body portion in a longitudinal direction, wherein at least one of the end plates is made of a material transparent to the ultraviolet rays, and the ultraviolet irradiation means is disposed to irradiate the ultraviolet rays through the at least one transparent end plate.

13. The apparatus of claim 12, wherein the end plates comprises a first end plate installed at one end portion of the body portion in the longitudinal direction and a second end plate disposed at the other end portion, wherein both the first end plate and the second end plate are made of materials transparent to the ultraviolet rays, and the ultraviolet irradiation means includes a first ultraviolet irradiation means for irradiating the ultraviolet rays through the first end plate, a second ultraviolet irradiation means for irradiating the ultraviolet rays through the second end plate.

14. The apparatus of claim 1, wherein the reactor includes a cylindrical body portion and end plates disposed at both ends of the body portion in a longitudinal direction, and the body portion has a window made of a material transparent to the ultraviolet rays.

15. A method for preparing trifluoramine oxide, comprising the steps of:
supplying vapor phase FNO and F₂ into a reactor;
irradiating ultraviolet rays having a peak in a wavelength band of 300 nm to 400 nm into the reactor;
discharging products from the reactor; and
separating and collecting F₃NO from the discharged products,
wherein the ultraviolet rays are such that an intensity of rays having a wavelength band of less than 300 nm is less than 5% of an intensity of rays having a wavelength band of 300 nm to 400 nm.

16. The method of claim 15, wherein the ultraviolet rays have a peak in a wavelength band of 350 nm to 370 nm, and the intensity of the rays having the wavelength band of less than 300 nm is 1% less than the intensity of the rays having the wavelength band of 300 nm to 400 nm.

17. The method of claim 16, wherein the ultraviolet rays have a single wavelength of 365 nm.

18. The method of claim 15, further comprising a step of purging the inside of the reactor with an inert gas before the step of supplying.

19. The method of claim 15, wherein in the step of supplying, a reaction zone in the reactor is flushed by at least one of F₂ and FNO.

20. The method of claim 15, wherein in the step of irradiating the ultraviolet rays, an ultraviolet irradiation time is controlled in real time based on the amount of F₃NO generated in the reactor.

21. The method of claim 20, wherein the amount of F₃NO generated in the reactor is measured by infrared spectroscopy.
